(19) United States
(12) Patent Application Publication
(10) Pub. No.: US 2015/0286694 A1
(43) Pub. Date: Oct. 8, 2015

(54) INTEGRATING A MOBILE PAYMENT APPLICATION WITH OTHER APPLICATIONS UTILIZING ANALYTIC ANALYSIS

(71) Applicant: International Business Machines Corporation, Armonk, NY (US)

(72) Inventors: Todd E. Kaplinger, Raleigh, NC (US); Gal Shachor, Yokneam (IL); Gregory L. Truty, Austin, TX (US)

(73) Assignee: International Business Machines Corporation, Armonk, NY (US)

(21) Appl. No.: 14/247,424

(22) Filed: Apr. 8, 2014

(51) Int. Cl. G06F 17/30; H04L 29/08; G06Q 20/32

(52) U.S. Cl. CPC G06F 17/30575; G06Q 20/32; H04L 67/22; G06F 17/30876

(57) ABSTRACT

A method, system and computer program product for integrating a mobile payment application with other applications utilizing analytic analysis. The user usage of applications, including a mobile payment application as well as other mobile applications, on a mobile computing device is tracked. For example, user interactions, such as checking a rewards balance, may be tracked. Analytic analysis may then be applied to the tracked user interactions to identify data and actions to sync between the mobile payment application and the other mobile applications on the mobile computing device as well as with other applications on other computing devices of the user that are identified via a user identification. In this manner, the mobile payment application is seamlessly integrated with the other mobile applications on the mobile computing device as well as with other applications on other computing devices of the user.

### TECHNICAL FIELD

The present invention relates generally to mobile payment applications, and more particularly to integrating a mobile payment application with other applications utilizing analytic analysis.

### BACKGROUND

Mobile payment applications, such as Apple's Passbook®, allow users to store gift cards, generic cards and other forms of mobile payment. Each card or form of mobile payment may be known as a “pass” or a “payment token.” Each pass may consist of a collection of JavaScript Object Notation (JSON) files and images.

Currently, passes are treated as a separate entity that are hosted by the mobile payment application, separate from other applications, including the business application that may have generated the card (e.g., gift card) used to create the pass. For example, Starbucks® has a mobile application that allows the user to create gift cards, select favorite store locations as well as monitor and track rewards. When a gift card is created, a pass (e.g., Starbucks® pass) corresponding to the gift needs to be created in order for the mobile payment application to use the gift card. In another example, when the user selects a favorite store location in the Starbucks® application, the mobile payment application does not inherit these preferences until the mobile payment application is accessed thereby allowing such preferences to be inherited by the Starbucks® pass stored in the mobile payment application. As a result, there is a period of time in which the mobile payment application does not have access to the user's preferences or mobile payments which may result in an undesired user experience.

Hence, there is currently not a means for seamlessly integrating the mobile payment application with the other existing mobile applications.

### BRIEF SUMMARY

In one embodiment of the present invention, a method for integrating a mobile payment application with other applications utilizing analytic analysis comprises tracking user usage of applications on a mobile computing device, where the applications comprise the mobile payment application deployed on the mobile computing device. The method further comprises applying, by a processor, analytic analysis to the tracked user usage of applications to identify data and actions to sync between the mobile payment application and other applications on the mobile computing device. The method additionally comprises syncing the data and actions between the mobile payment application and other applications on the mobile computing device as a user of the mobile computing device accesses the applications.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a hardware configuration of a mobile device for practicing the principles of the present invention in accordance with an embodiment of the present invention;

FIG. 2 is a diagram of the software components used in connection with integrating the mobile payment application with other mobile applications in accordance with an embodiment of the present invention;

FIG. 3 is a flowchart of a method for integrating the mobile payment application with the other mobile applications on the mobile computing device as well as with other applications on another device in accordance with an embodiment of the present invention; and

FIG. 4 illustrates the tracked interactions of the user with the mobile payment application and the other mobile applications deployed on the mobile computing device in accordance with an embodiment of the present invention.

### DETAILED DESCRIPTION

The present invention comprises a method, system and computer program product for integrating a mobile payment application with other applications utilizing analytic analysis. In one embodiment of the present invention, the user usage of applications, including a mobile payment application as well as other mobile applications, on a mobile computing device is tracked. For example, user interactions, such as creating a digital coupon or ticket, e-mailing the digital coupon or ticket, checking proximity to a store location, checking a rewards balance, adding a favorite store, debiting a payment card or gift card, crediting a payment card or gift card, updating a preference and purchasing a gift card, may be tracked. Analytic analysis may then be applied to the tracked user interactions to identify data and actions to sync between the mobile payment application and the other mobile applications on the mobile computing device as well as with other applications on other computing devices of the user that are identified via a user identification. For example, analytic analysis may involve analytic code configured to capture the data (e.g., a digital coupon, a digital coupon, a gift card, a preference, a location, rewards, cookies) and actions (e.g., creating a digital coupon or ticket, e-mailing the digital coupon or ticket, checking proximity to a store location, checking a rewards balance, adding a favorite store, debiting a payment card or gift card, crediting a payment card or gift card, updating a preference and purchasing a gift card) from the tracked user actions that would be utilized by the mobile payment application. The data and actions are then synced between the mobile payment application and the other mobile applications on the mobile computing device as well as with other applications on other computing devices of the user. In this manner, the mobile payment application is seamlessly integrated with the other mobile applications on the mobile computing device as well as with other applications on other computing devices of the user.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

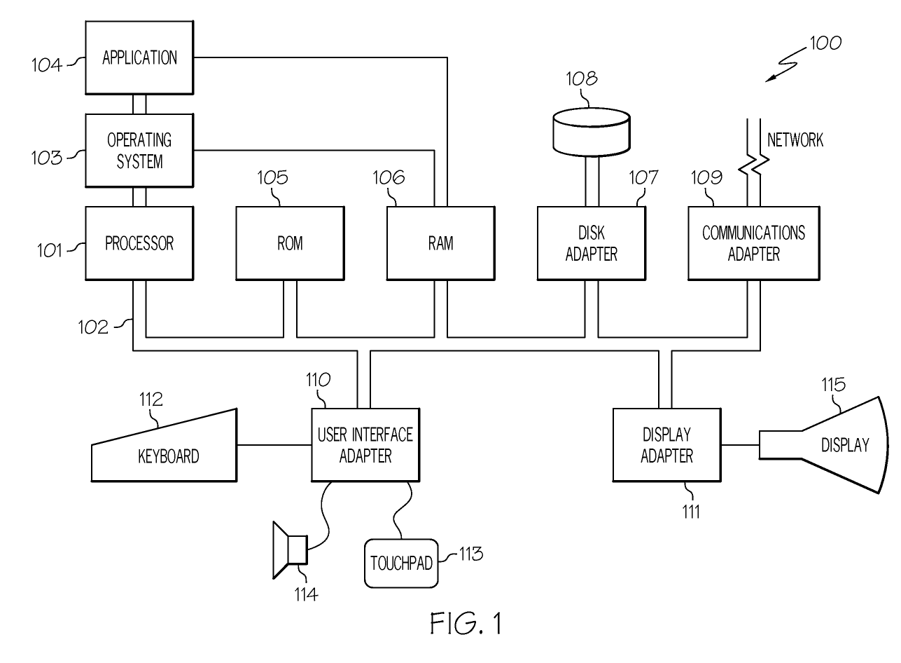

Referring now to the Figures in detail, FIG. 1 illustrates a hardware configuration of a mobile computing device 100 for practicing the principles of the present invention in accordance with an embodiment of the present invention. Mobile computing device 100 may be any mobile computing device, including, but not limited to, a mobile phone, a cellular phone, a smartphone, a personal digital assistance (PDA), a gaming unit, a portable computing unit, a tablet computer and the like.

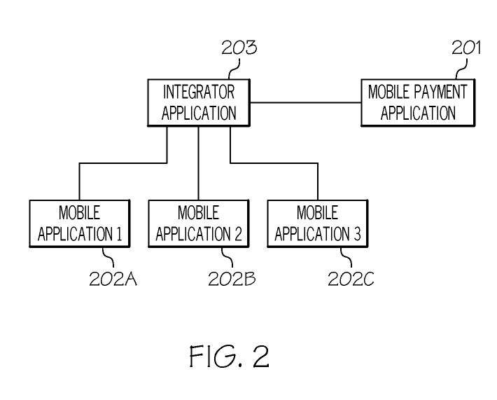

As illustrated in FIG. 1, mobile computing device 100 has a processor 101 coupled to various other components by system bus 102. An operating system 103 runs on processor 101 and provides control and coordinates the functions of the various components of FIG. 1. An application 104 in accordance with the principles of the present invention runs in conjunction with operating system 103 and provides calls to operating system 103 where the calls implement the various functions or services to be performed by application 104. Application 104 may include, for example, a program for integrating a mobile payment application with other applications utilizing analytic analysis as discussed further below in association with FIGS. 2-4.

Referring again to FIG. 1, read-only memory (“ROM”) 105 is coupled to system bus 102 and includes a basic input/output system (“BIOS”) that controls certain basic functions of mobile computing device 100. Random access memory (“RAM”) 106 and disk adapter 107 are also coupled to system bus 102. It should be noted that software components including operating system 103 and application 104 may be loaded into RAM 106, which may be mobile computing device's 100 main memory for execution. Disk adapter 107 may be an integrated drive electronics (“IDE”) adapter that communicates with a disk unit 108, e.g., disk drive. It is noted that the program for integrating a mobile payment application with other applications utilizing analytic analysis, as discussed further below in association with FIGS. 2-4, may reside in disk unit 108 or in application 104.

Mobile computing device 100 may further include a communications adapter 109 coupled to bus 102. Communications adapter 109 interconnects bus 102 with an outside network thereby enabling mobile computing device 100 to communicate with other devices (e.g., computer networking devices, mobile computing devices).

I/O devices may also be connected to mobile computing device 100 via a user interface adapter 110 and a display adapter 111. Keyboard 112, touchpad 113 and speaker 114 may all be interconnected to bus 102 through user interface adapter 110. A display monitor 115 may be connected to system bus 102 by display adapter 111. In this manner, a user is capable of inputting to mobile computing device 100 through keyboard 112 or touchpad 113 and receiving output from mobile computing device 100 via display 115 or speaker 114. Other input mechanisms may be used to input data to mobile computing device 100 that are not shown in FIG. 1, such as display 115 having touch-screen capability and keyboard 112 being a virtual keyboard. Mobile computing device 100 of FIG. 1 is not to be limited in scope to the elements depicted in FIG. 1 and may include fewer or additional elements than depicted in FIG. 1.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, mobile payment applications, such as Apple's Passbook®, allow users to store gift cards, generic cards and other forms of mobile payment. Each card or form of mobile payment may be known as a “pass” or a “payment token.” Each pass may consist of a collection of JavaScript Object Notation (JSON) files and images. Currently, passes are treated as a separate entity that are hosted by the mobile payment application, separate from other applications, including the business application that may have generated the card (e.g., gift card) used to create the pass. For example, Starbucks® has a mobile application that allows the user to create gift cards, select favorite store locations as well as monitor and track rewards. When a gift card is created, a pass (e.g., Starbucks® pass) corresponding to the gift needs to be created in order for the mobile payment application to use the gift card. In another example, when the user selects a favorite store location in the Starbucks® application, the mobile payment application does not inherit these preferences until the mobile payment application is accessed thereby allowing such preferences to be inherited by the Starbucks® pass stored in the mobile payment application. As a result, there is a period of time in which the mobile payment application does not have access to the user's preferences or mobile payments which may result in an undesired user experience. Hence, there is currently not a means for seamlessly integrating the mobile payment application with the other existing mobile applications.

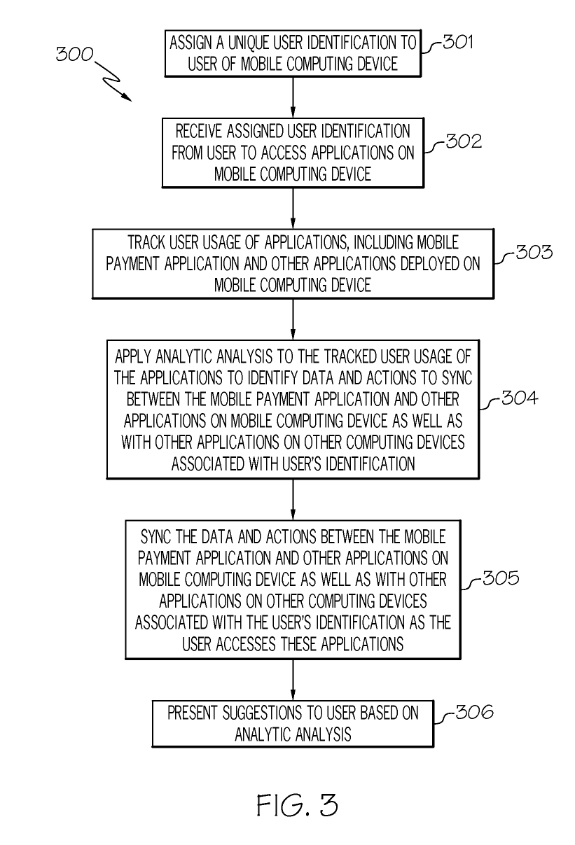

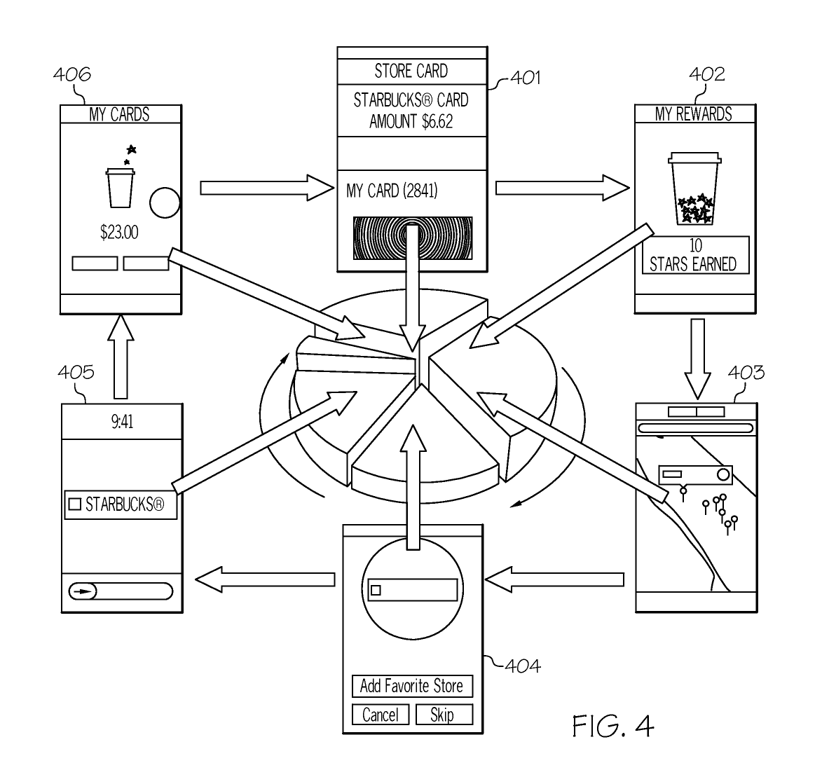

The principles of the present invention provide a means for seamlessly integrating the mobile payment application with the other mobile applications by utilizing analytic analysis as discussed below in connection with FIGS. 2-4. FIG. 2 is a diagram of the software components used in connection with integrating the mobile payment application with the other mobile applications. FIG. 3 is a flowchart of a method for integrating the mobile payment application with the other mobile applications on the mobile computing device as well as with other applications on another device. FIG. 4 illustrates the tracked interactions of the user with the mobile payment application and the other mobile applications deployed on the mobile computing device.

As stated above, FIG. 2 is a diagram of the software components used in connection with integrating the mobile payment application with the other mobile applications in accordance with an embodiment of the present invention. In one embodiment, these software components may reside in application 104 (FIG. 1).

The following provides a brief description of these software components. A more detailed description of these software components (including their functionalities) is provided below in conjunction with FIGS. 3-4.

Referring to FIG. 2, the software components include a mobile payment application 201, such as Apple's Passbook®, which is used by the user of mobile computing device 100 (FIG. 1) to store a pass. A “pass,” as used herein, refers to a form of mobile payment, such as a gift card, a credit card, etc. The pass may consist of a collection of JavaScript Object Notation (JSON) files and images.

The software components further include other mobile applications 202A-202C (identified as “mobile application 1,” “mobile application 2,” and “mobile application 3,” respectively, in FIG. 2) (e.g., enterprise applications, such as the Starbucks® application that allows the user to create gift cards, select favorite store locations as well as monitor and track rewards) that may be used by the user of mobile computing device 100. Mobile applications 202A-202C may collectively or individually be referred to as mobile applications 202 or mobile application 202, respectively. Mobile application 202 may include any application on mobile computing device 100 that has the possibility of interacting with mobile payment application 201, such as enterprise applications or device applications (e.g., camera application, e-mail application). While FIG. 2 illustrates three mobile applications 202, mobile computing device 100 may include any number of mobile applications 202.

Furthermore, FIG. 2 illustrates an application, referred to herein as the “integrator application” 203, configured to integrate mobile payment application 201 with the other mobile applications 202 as discussed further below in connection with FIGS. 3-4. Furthermore, in one embodiment, integrator application 203 is configured to integrate mobile payment application 201 on mobile computing device 100 with other applications (whether mobile or non-mobile applications) on other user devices (whether mobile or non-mobile, such as a desktop computer, a portable computing unit, a Personal Digital Assistant (PDA), a smartphone, a laptop computer, a tablet computer, a mobile phone, a navigation device, a game console, a workstation, an Internet appliance and the like) as discussed further below.

As stated above, FIG. 3 is a flowchart of a method 300 for integrating mobile payment application 201 (FIG. 2) with other mobile applications (e.g., mobile applications 202) on mobile computing device 100 as well as with other applications on another device in accordance with an embodiment of the present invention.

Referring to FIG. 3, in conjunction with FIGS. 1-2, in step 301, integrator application 203 assigns a unique user identification to the user of mobile computing device 100. In one embodiment, such a user identifier is used to prevent unauthorized users from accessing the applications on mobile computing device 100. Furthermore, such a user identifier is used to integrate mobile payment application 201 on mobile computing device 100 with other applications on other user devices as discussed further below.

In step 302, integrator application 203 receives the assigned user identification from the user of mobile computing device 100 to access the applications (e.g., mobile payment application 201, mobile applications 202) on mobile computing device 100.

In step 303, integrator application 203 tracks user usage of the applications, such as mobile payment application 201 and mobile applications 202 (e.g., business application, web application, merchant application) deployed on mobile computing device 100 in response to receiving the assigned user identification from the user of mobile computing device 100. For example, integrator application 203 may track the user's interactions with mobile payment 201 and other mobile applications 202 deployed on mobile computing device 100 as illustrated in FIG. 4. FIG. 4 illustrates the tracked interactions of the user with mobile payment application 201 and the other mobile application 202 deployed on mobile computing device 100 in accordance with an embodiment of the present invention.

Referring to FIG. 4, the user's interactions may include viewing a merchant gift card 401 (e.g., Starbucks® gift card) in mobile payment application 201, checking the user's rewards balance 402 using a merchant application (e.g., Starbucks®), checking the proximity to a store location 403 in a web application, adding a favorite store 404 using the merchant application, being notified 405 when the user of mobile computing device 100 is in close proximity to a favorite store via mobile payment application 201 and viewing the balance of a gift card 406 using the merchant application.

As illustrated in FIG. 4, the user of mobile computing device 100 may be constantly switching context between mobile payment application 201 and the other mobile applications 202. These and other interactions, such as creating a digital coupon or ticket (digital coupon or ticket referred to as a “pass”), e-mailing the digital coupon or ticket, debiting a payment card or gift card, crediting a payment card or gift card, updating a preference (e.g., adding a favorite store), etc., may be tracked by integrator application 203. It is noted that the principles of the present invention are not to be limited in scope to the listed interactions but to include any interaction where the interaction involves data and actions to be used by mobile payment application 201.

Returning to FIG. 3, in conjunction with FIGS. 1-2 and 4, in step 304, integrator application 203 applies analytic analysis to the tracked user usage of the applications to identify data and actions to sync between mobile payment application 201 and other mobile applications 202 on mobile computing device 100 as well as with other applications on other computing devices of the user associated with the user's identification. In one embodiment, analytic analysis may involve analytic code configured to capture the data (e.g., a digital coupon, a digital coupon, a gift card, a preference, a location, rewards, cookies) and actions (e.g., creating a digital coupon or ticket, e-mailing the digital coupon or ticket, checking proximity to a store location, checking a rewards balance, adding a favorite store, debiting a payment card or gift card, crediting a payment card or gift card, updating a preference and purchasing a gift card) from the tracked user actions that would be utilized by mobile payment application 201. In one embodiment, the data and actions to be synced may involve other applications on other devices that are associated with the user via the user's identification that was assigned to the user in step 301. For example, passes may be shared across all of the user's devices. For instance, an application 202 (e.g., merchant application) shares a pass with an application on another user device identified by the user's identification. Such actions may be identified to be synced with mobile payment application 201. In one embodiment, all of the user's devices (i.e., user of mobile computing device 100) may be associated with the user's identification (user identification assigned in step 301) thereby allowing these devices to be identified with the user as well as allowing mobile payment application 201 to be seamlessly integrated with other applications on other computing devices of the user associated with the user's identification as discussed further below.

In one embodiment, analytic analysis is applied in response to various user actions as discussed above in step 303, such as creating a digital coupon or ticket (digital coupon or ticket referred to as a “pass”), e-mailing the digital coupon or ticket, checking proximity to a store location, checking a rewards balance, adding a favorite store, debiting a payment card or gift card, crediting a payment card or gift card, updating a preference and purchasing a gift card.

In step 305, integrator application 203 syncs the data and actions between mobile payment application 201 and the other mobile applications 202 on mobile computing device 100 as well as with other applications on other computing devices of the user associated with the user's identification as the user accesses these applications. In this manner, mobile payment application 201 is seamlessly integrated with other mobile applications 202 on mobile computing device 100 as well as with other applications on other computing devices of the user associated with the user's identification.

In step 306, integrator application 203 presents suggestions to the user of mobile device 100 based on analytic analysis. For example, integrator application 203 may present a suggestion as to a new location of a merchant to be designated as a favorite location based on other locations that were previously defined as the user's favorite locations. In another example, integrator application 203 may present a suggestion as to a new location of a store to be designated as a favorite location based on the store locations visited by the user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A computer program product for integrating a mobile payment application with other applications utilizing analytic analysis, the computer program product comprising a computer readable storage medium having program code embodied therewith, the program code comprising the programming instructions for:
tracking user usage of applications on a mobile computing device, wherein said applications comprise said mobile payment application deployed on said mobile computing device;
applying analytic analysis to said tracked user usage of applications to identify data and actions to sync between said mobile payment application and other applications on said mobile computing device; and
syncing said data and actions between said mobile payment application and other applications on said mobile computing device as a user of said mobile computing device accesses said applications.

9. The computer program product as recited in claim 8, wherein the program code further comprises the programming instructions for:
assigning a user identification to said user of said mobile computing device; and
receiving said assigned user identification from said user to access said applications on said mobile computing device.

10. The computer program product as recited in claim 9, wherein the program code further comprises the programming instructions for:
applying said analytic analysis to said tracked user usage of applications to identify data and actions to sync between said mobile payment application and other applications on other computing devices associated with said assigned user identification.

11. The computer program product as recited in claim 8, wherein the program code further comprises the programming instructions for:
presenting suggestions to said user of said mobile computing device based on said analytic analysis.

12. The computer program product as recited in claim 8, wherein said data to be synced between said mobile payment application and other applications on said mobile computing comprises one or more following: a digital coupon, a digital ticket, a gift card, a preference, a location, rewards and cookies.

13. The computer program product as recited in claim 8, wherein said analytic analysis is applied responsive to one or more of the following user actions: creating a digital coupon or ticket, e-mailing a digital coupon or ticket, checking proximity to a store location, checking a rewards balance, adding a favorite store, debiting a payment card or gift card, crediting a payment card or gift card, updating a preference and purchasing a gift card.

14. The computer program product as recited in claim 8, wherein said data and actions are synced between said mobile payment application and one or more of the following applications: a business application, a web application and a merchant application.

15. A system, comprising:
a memory unit for storing a computer program for integrating a mobile payment application with other applications utilizing analytic analysis; and
a processor coupled to the memory unit, wherein the processor is configured to execute the program instructions of the computer program comprising:
tracking user usage of applications on a mobile computing device, wherein said applications comprise said mobile payment application deployed on said mobile computing device;
applying analytic analysis to said tracked user usage of applications to identify data and actions to sync between said mobile payment application and other applications on said mobile computing device; and
syncing said data and actions between said mobile payment application and other applications on said mobile computing device as a user of said mobile computing device accesses said applications.

16. The system as recited in claim 15, wherein the program instructions of the computer program further comprises:
assigning a user identification to said user of said mobile computing device; and
receiving said assigned user identification from said user to access said applications on said mobile computing device.

17. The system as recited in claim 16, wherein the program instructions of the computer program further comprises:
applying said analytic analysis to said tracked user usage of applications to identify data and actions to sync between said mobile payment application and other applications on other computing devices associated with said assigned user identification.

18. The system as recited in claim 15, wherein the program instructions of the computer program further comprises:
presenting suggestions to said user of said mobile computing device based on said analytic analysis.

19. The system as recited in claim 15, wherein said data to be synced between said mobile payment application and other applications on said mobile computing comprises one or more following: a digital coupon, a digital ticket, a gift card, a preference, a location, rewards and cookies.

20. The system as recited in claim 15, wherein said analytic analysis is applied responsive to one or more of the following user actions: creating a digital coupon or ticket, e-mailing a digital coupon or ticket, checking proximity to a store location, checking a rewards balance, adding a favorite store, debiting a payment card or gift card, crediting a payment card or gift card, updating a preference and purchasing a gift card.

21. The system as recited in claim 15, wherein said data and actions are synced between said mobile payment application and one or more of the following applications: a business application, a web application and a merchant application.
